(19) United States
(12) Patent Application Publication
(10) Pub. No.: US 2008/0120672 A1
(43) Pub. Date: May 22, 2008

(54) Methods and Apparatus for Weighted Multicasting of Data Streams

(76) Inventor: Francesco Caggioni, Winchester, MA (US)

Correspondence Address: GORDON & JACOBSON, P.C., 60 LONG RIDGE ROAD, SUITE 407, STAMFORD, CT, 06902, US

(21) Appl. No.: 11/561,933

(22) Filed: Nov. 21, 2006

(51) Int. Cl. H04N 7/173

(52) U.S. Cl. 725/118

(57) ABSTRACT

A multicast table which associates data streams with recipients has more values than zero and one. By making this change in multicast tables, several interesting applications can be implemented. Applications include digital TV transmission, combined transmission of different bandwidth signals, video conferencing applications and mirror web server updating applications.

### BACKGROUND OF THE INVENTION

1. Field of the Invention

This invention relates broadly to telecommunications. More particularly, this invention relates to multicasting of data streams. The invention has many applications, one of which is the multicasting of audiovisual media streams.

2. State of the Art

The term “broadcasting” entered the telecommunications lexicon in the 1920s during the dawn of commercial radio entertainment. Later it was applied to over-the-air television. It generally means to transmit over the air so that anyone within range of the transmitter can receive the radio or television signal and perceive its content.

As telecommunications technology has evolved, much of what is communicated today travels to the receiver by wire, or in some cases, by fiber optic. Signals which are sent out to all of the subscribers of a cable television system were first said to be “cablecast” which means broadcast over cable. Most modern cable television systems cablecast a number of channels simultaneously as analog or digital signals and a number of channels on an as requested basis as digital signals. Moreover, the digital signals not only can be broadcast or cablecast, they can be individually “addressed” to each subscriber that has requested them.

Digital television signals may be High Definition (HDTV) or normal definition (TV). In the latter case, the digital signal is typically converted to an analog signal inside the subscriber's set top box before being sent to an analog TV receiver. However, if the set top box is connected to a digital TV no conversion is necessary. The digital signals are typically transmitted as packetized MPEG streams. MPEG (pronounced M-peg), which stands for Moving Picture Experts Group, is the nickname given to a family of International Standards used for coding audio-visual information in a digital compressed format. The MPEG family of standards includes MPEG-1, MPEG-2 and MPEG-4, formally known as ISO/IEC-11172, ISO/IEC-13818 and ISO/IEC-14496. MPEG-1 was released in 1992. It was designed for audio and video to be played on a computer screen from a CD-ROM or hard disk. The MPEG-1 frame is generally 320×240 pixels. MPEG-2 issued in 1994. It is the more popular coding standard for TV and HDTV. It has a frame size of generally 720×480 pixels although other sizes are possible. MPEG-4 is based on MPEG-1, MPEG-2, and Apple Computer's QuickTime technology.

An analog video stream consists of two interlaced frames which are transmitted at 60 frames per second to create 30 full image frames per second. Digital video is often not interlaced. Full frames are transmitted at a rate of at least 15 full frames per second. MPEG video compression is achieved by transmitting less than the entire video signal and then recreating the entire video signal at the receiver using certain algorithms.

Generally speaking, an MPEG video stream consists of three or four different kinds of frames: I frames (intracoded frames), P frames (predicative interceded frames), B frames (bidirectional predictive interceded frames), and D frames (DC coded frames).

I frames are compressed without reference to any other frames. That is, they are compressed using just the information in the frame itself, in the same way still images are compressed. This is called intracoding. There are generally two or more I frames in each second of video (more often three to six per second), and particularly complex frames are encoded as I frames.

P and B frames are encoded with reference to the previous frame, i.e., they are intercoded. P frames are encoded with reference only to a previous frame. This is called forward prediction. B frames are encoded with reference to both the previous frame and the next frame. This is called forward and backward prediction. Use of forward and backward prediction makes a high compression rate possible, because it is necessary to record/transmit only the changes from one frame to the next.

An I frame plus the following B and P frames before the next I frame together define a Group of Pictures (GOP). The size of the GOP can be set to optimize encoding to suit different movies and display formats. Most commonly a GOP is 15 frames long, and has the sequence IBBPBBPBBPBBPBB. A similar 12-frame sequence is also common.

Macroblocks are blocks of 16 pixels by 16 pixels within a frame. The encoder uses motion compensated prediction for P frames and B frames. That is, it detects macroblocks that don't change from one frame to the next, or that change only by moving. For each macroblock, a search is made for the closest match in the search area of the previous frame. When a match is found, a motion vector is computed. The motion vector records how far the macroblock has moved, and in what direction.

When only one subscriber has requested a particular video stream, it is said to be unicast. When two or more subscribers have requested the same video stream, it is said to be multicast. Most cable TV systems deploy several multicast engines throughout their network in order to serve a greater number of subscribers. Each multicast engine is associated with a multicast table (a two dimensional matrix) which associates video streams with subscribers. Prior art FIG. 6 shows a multicast engine which serves four video streams to five customers. Table 1 below illustrates how the multicast table would be set up for the multicast illustrated in FIG. 6. The table associates subscribers with video streams. A logic zero entry means “do not forward this stream to this customer”. A logic one entry means “do forward this stream to this customer”.

TABLE 1

| | Channel 72 | Ch. 72 HD | Channel 111 | Channel 248 |
|---|---|---|---|---|
| Subscriber A | 1 | 0 | 0 | 0 |
| Subscriber B | 0 | 0 | 0 | 1 |
| Subscriber C | 0 | 0 | 1 | 0 |
| Subscriber D | 0 | 0 | 0 | 1 |
| Subscriber E | 0 | 1 | 0 | 0 |

When a subscriber requests a video stream, a signal is sent from the subscriber's set top box to an administration computer connected to the network. The administration computer receives the request and (assuming there is no need to perform a pay-per-view dialog) sends a message to the multicast engine to add this subscriber and video stream to the multicast table. As seen in Table 1, subscriber A has selected channel 72; subscribers B and D have selected channel 248; and subscriber C has selected channel 111. Subscriber E has selected the HD version of channel 72. As other subscribers select other or the same channels, the table will be expanded until capacity is filled. Then other multicast engines will be called upon to fulfill requests. It will be appreciated that if a subscriber has more than one set top box, each coupled to a different TV set, they will be treated as separate subscribers in the multicast table.

After a channel is selected, the compressed MPEG video stream must then be synchronized with a decompressor in the customer's set top box. Synchronization occurs after receipt of the first I frame. Unlike changing analog channels, which appears to take place instantly, setting up the multicast entries and synchronizing the I frames takes place during a perceivable delay. This delay appears in most digital video delivery systems, not just cable TV systems. Other systems which are affected by this delay include Internet Protocol TV (IPTV), Multiple Service Operators (MSOs), and Telcos delivering video via Digital Subscriber Lines (DSL).

It is believed that some customers find this delay annoying, particularly when “channel surfing” (i.e. stepping through channels one after the other). Thus, there is an apparent need to eliminate or minimize this delay.

### SUMMARY OF THE INVENTION

It is therefore an object of the invention to provide methods for eliminating or minimizing the delay when changing channels of digital video streams.

It is another object of the invention to provide a multicasting system which implements quality of service policies.

It is a further object of the invention to provide a multicasting system which implements an hierarchical encoding model.

It is also an object of the invention to provide a multicasting system in which streams are assigned weights indicating how many frames in a GOP may be discarded.

It is still another object of the invention to provide a multicasting system which optimizes the way content is delivered to a network.

In accord with these objects, which will be discussed in detail below, the methods of the invention include providing a multicast table wherein table entries which associate data streams with recipients can have more values than zero and one. By making this simple change in multicast tables, several interesting applications can be implemented.

According to a first application of the invention, a multicast table entry associating video streams with TV subscribers may have the logical values zero, one, or two. The entries zero and one have the same function as existing multicast tables. The entry two indicates a stream of I frames only. When a subscriber first selects a channel, the methods of the invention propose making additional table entries such that the subscriber will receive all frames of the selected channel as well as I frames from the two adjacent channels. In this manner, when the subscriber surfs up or down a channel, a still picture of the program will be immediately available and motion will begin quickly as soon as the next frame is received.

According to a second application of the invention, quality of service policies are implemented by providing a fourth logical value for each stream such as forward all frames but mark less important frames with a discard bit. If downstream resources are unavailable, the frames with a discard bit will be dropped. This provides a weight for each frame in the stream. The weight can also be used to trigger other operations within the network such as marking packets with standard or proprietary tags which will determine how the packets are treated by the network. For example, the “forward I frames only” weight could be tagged as low priority traffic such that the frames would be dropped during network congestion. When the network is not congested, the delivery of these frames will enhance the subscriber experience.

According to a third application of the invention, frames from a low bandwidth mobile video stream are mixed with selected frames from a standard definition stream and selected frames from a high definition stream. Today video is delivered to hand held devices via various technologies, one of which is referred to as V-casting. A V-cast signal is typically sent at a rate of 256 Kbps or less via a cellular telephone network. The same operators of these cellular networks may also be providing higher quality video signals via digital subscriber lines (DSL) or other wired or wireless technologies. These higher quality signals may include HDTV. Thus, a content provider or a video distribution hub within the provider's network may need to supply the network provider with three versions of the same content. This is illustrated in prior art FIG. 7.

Prior art FIG. 7 shows a multicast engine that receives three different versions of the same content (e.g. channel 72) at varying bandwidths to support a V-cast to a cell phone, a data stream to a standard TV set and a data stream to an HDTV set. This seems to be an inefficient way to deliver content to a network provider.

An application of the present invention creates a hierarchical encoding model whereby three sub-signals are carried in the same stream which can be adapted to the needs of three different subscribers by filtering out the unneeded frames. For example, a combination signal representing all three bandwidths can be based on a V-cast stream with additional delta frames for standard TV and additional delta frames for HDTV. A multicast table with four values for each entry will specify to forward: no frames, V-cast frames only, V-cast plus delta frames for TV, or the entire stream for HDTV. This aspect of the invention also allows the downgrading of a signal rather than an interruption of the signal in the event of network congestion. For example, a signal containing components of HDTV, TV and mobile V-cast video could be delivered to an HD subscriber and downgraded to TV in the event of congestion. Similarly, a TV subscriber could be downgraded to V-cast video quality in the event of network congestion.

Still another application of the weighted multicast table of the invention is applied to teleconferencing. In modern teleconferencing, audio and video signals are sent to all participants. In addition, a whiteboard or computer desktop signal is also sent to all participants. Implementation of the present invention can allow participants with limited bandwidth to choose to not receive the video portion of the conference or to not receive the desktop portion or to only receive the audio portion.

The weighted multicast table of the invention can also be applied to the updating of mirror web servers. Many commercial websites have “mirror” servers located in different parts of the world. The mirror sites distribute the load on the web site geographically. When the main web server is updated, the mirrors must be updated as well. Depending on the importance of the update to the mirror servers, the weighted multicast table can be used to differentiate the frequency of updates to different mirrors.

An alternative implementation of assigning weights to streams is to associate additional rows in the table with each stream, each row representing a different weight. Thus, the table entries could remain binary and this will be more compatible with existing systems.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic block diagram illustrating a first application of the invention;

FIG. 2 is a schematic block diagram illustrating a second application of the invention;

FIG. 3 is a schematic block diagram illustrating a third application of the invention;

FIG. 4 is a schematic block diagram illustrating a fourth application of the invention;

FIG. 5 is a schematic block diagram illustrating a fifth application of the invention;

FIG. 6 is a schematic block diagram illustrating a prior art multicasting arrangement; and

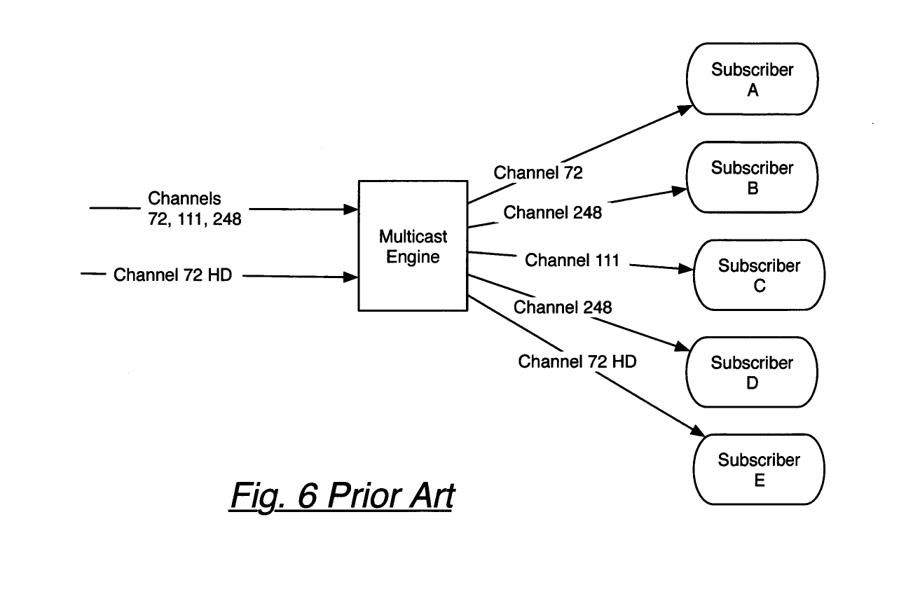

FIG. 7 is a schematic block diagram illustrating a prior art multicasting arrangement of different bandwidth signals of the same content.

### DETAILED DESCRIPTION OF THE PREFERRED EMBODIMENTS

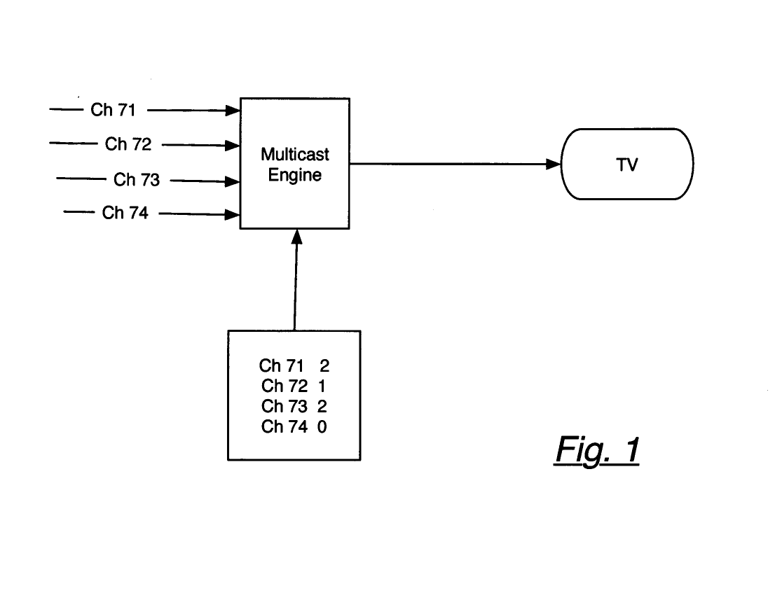

Referring now to FIG. 1 and Table 2 below, the present invention proposes a multicast table which can associate a data stream with a logical destination address in more than one way. According to the first example, when a digital TV subscriber selects a channel, e.g. channel 72, three entries are made in the multicast table. The entry for the selected channel is “1” which has the meaning of sending the full stream for channel 72 to the subscriber. The other two entries for the adjacent channels 71 and 73 are “2” which has the meaning of sending only I frames for these channels. Optionally, “2” could have the meaning of sending only every other or every third I frame. Entry

TABLE 2

| | Channel 71 | Channel 72 | Channel 73 | Channel 74 |
|---|---|---|---|---|
| TV Subscriber | 2 | 1 | 2 | 0 |

FIG. 1 shows data for channels 71, 72, 73, and 74 being sent to a multicast engine and a subset of the data being forwarded to the TV subscriber. As illustrated, only the I frames for channels 71 and 73 are sent to the multicast engine. However, in practice the multicast engine could receive the entire data stream for channels 71 and 73 and filter out all but the I frames for the channels having a “2” entry in the multicast table. In either case, when the subscriber surfs up or down a channel, a still picture of the program will be immediately available, the multicast table entries will be changed and motion will begin quickly as soon as the next GOP or I frame is received. The entry “0” for channel 74 means do not send any frames.

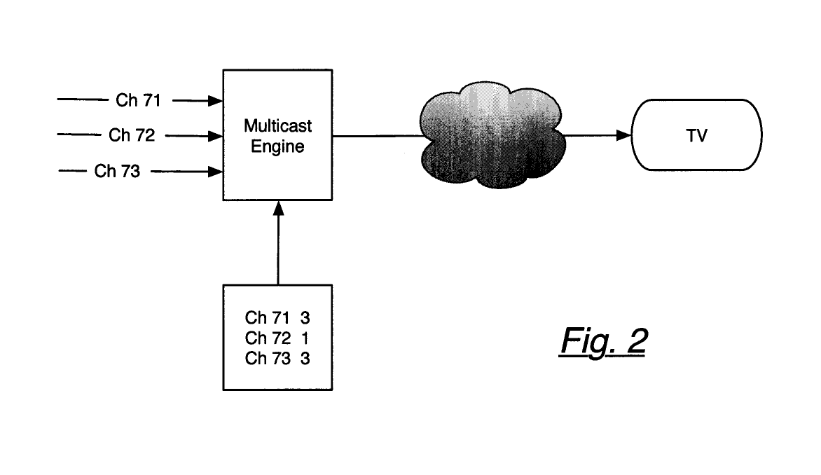

According to a second application of the invention, quality of service policies are implemented by providing a fourth entry for each stream such as “forward all frames but mark less important frames with a discard bit”. If downstream resources are unavailable, the frames with a discard bit will be dropped. This provides a weight for each portion of the stream. The weight can also be used to trigger other operations within the network such as marking packets with standard or proprietary tags which will determine how the packets are treated by the network. For example, the “forward I frames only” weight could be tagged as low priority traffic and the frames dropped during network congestion. When the network is not congested, the delivery of these frames will enhance the subscriber experience. An exemplary application is illustrated in FIG. 2 and Table 3.

TABLE 3

| | Channel 71 | Channel 72 | Channel 73 |
|---|---|---|---|
| TV Subscriber | 3 | 1 | 3 |

In the example of FIG. 2 and Table 3, the selected channel is 72 and the entry for that channel is “1” which indicates that all frames for that channel are to be forwarded to the subscriber. The table entries for channels 71 and 73 are “3” which indicates that all frames are to be forwarded but non-I frames are marked with a discard bit. If bandwidth is available, the subscriber will experience instantaneous channel changing to adjacent channels. If bandwidth is scarce, the user will experience the same perception as in the first application described above.

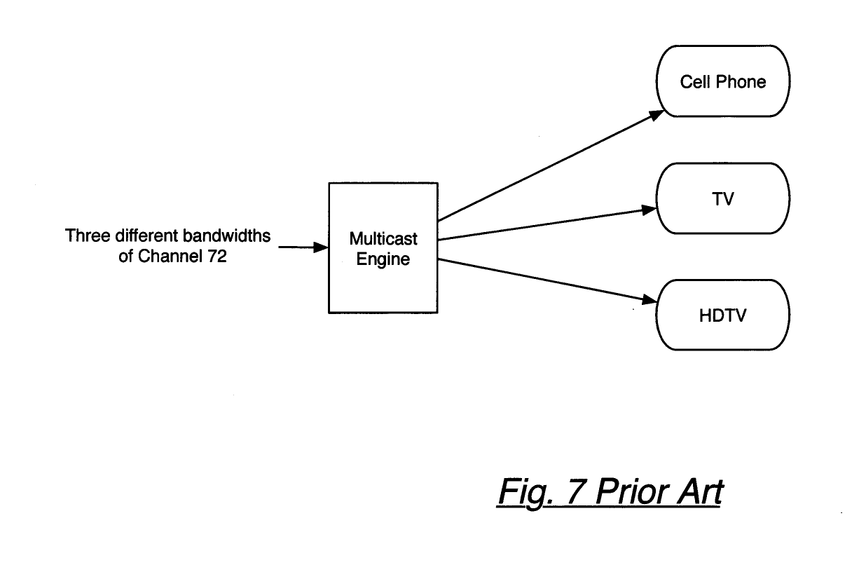

A third application of the invention involves the simultaneous transmission of different bandwidth signals carrying the same content at different resolutions. Rather than transmitting three separate streams as is done in the state of the art and as described above with reference to prior art FIG. 7, a single hybrid stream is created and then filtered at a multicast engine.

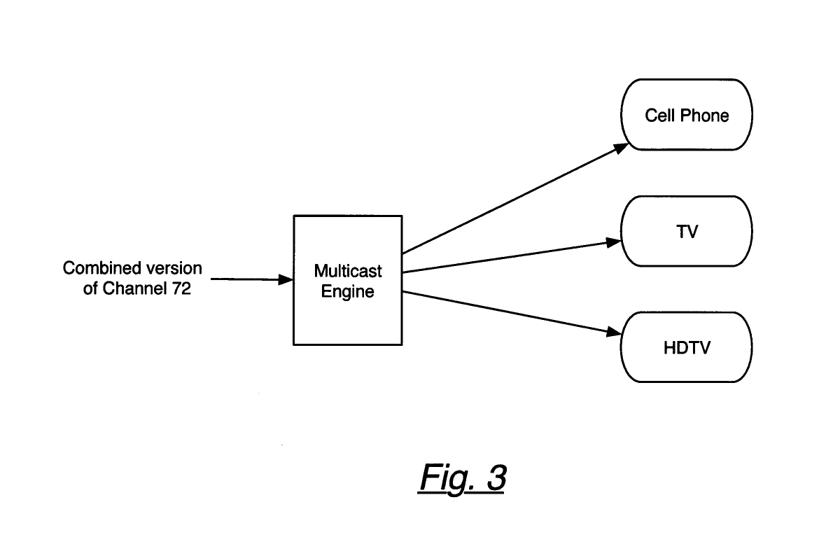

FIG. 3 shows a combined version of channel 72 being delivered to a multicast engine and different bandwidth signals being forwarded to a cell phone, a TV, and an HDTV. The combined (“hybrid”) signal could be created starting with the lowest bandwidth signal (e.g. V-cast), adding the differential information for a standard TV signal and then adding the differential information for an HDTV signal. Algebraically, the combined signal can be expressed as Vcast+ΔTV+ΔHDTV. The combined signal would require less bandwidth than transmitting three separate signals of different bandwidth. Table 4 shows how the multicast table should be arranged.

TABLE 4

| | Channel 72 |
|---|---|
| HDTV | 1 |
| TV | 2 |
| Cell Phone | 3 |

In this application, the multicast table entry “1” means “forward the entire signal Vcast+ΔTV+ΔHDTV”. The entry “2” means “forward all but the differential HDTV part”, i.e. Vcast+ΔTV. The entry “3” means “forward only the Vcast part of the signal”.

This third application of the present invention also allows the downgrading of a signal rather than an interruption of the signal in the event of network congestion. For example, a signal containing components of HDTV, TV and V-cast video could be delivered to an HDTV subscriber and downgraded to standard TV in the event of congestion. Similarly, a standard TV subscriber could be downgraded to V-cast video quality in the event of network congestion.

A fourth application of the weighted multicast table of the invention is applied to teleconferencing. In modern teleconferencing, audio and video signals are sent to all participants. In addition, a whiteboard or a computer desktop signal is also sent to all participants. Implementation of the present invention can allow participants with limited bandwidth to choose to not receive the video portion of the conference or to not receive the desktop portion or to only receive the audio portion.

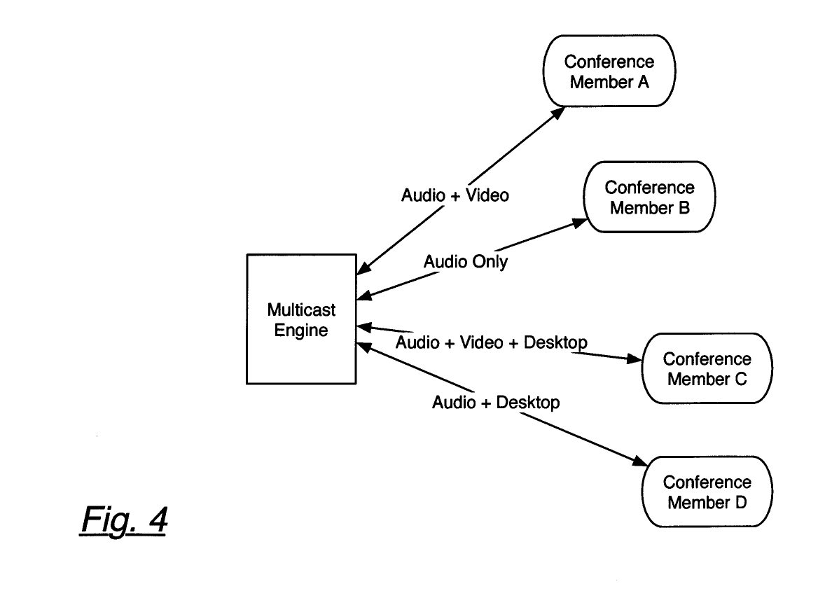

FIG. 4 illustrates a multicast engine bidirectionally coupled to three conference members. Member A receives audio and video from the multicast engine and transmits audio and video to it. Conference member B has only an audio connection. Conference member C has audio, video, and desktop viewing connections. Conference member D has audio and desktop viewing connections. The multicast table is represented by Table 5.

TABLE 5

| Member | Access Level |
|---|---|
| A | 2 |
| B | 1 |
| C | 3 |
| D | 4 |

In this example the table entry “1” means “audio only”. The table entry “2” means “audio and video”. The Table entry “3” means “audio, video, and desktop access”. With desktop access a conference member can view (and control) the computer desktop of another member who has desktop access. The Table entry “4” means audio and desktop access.

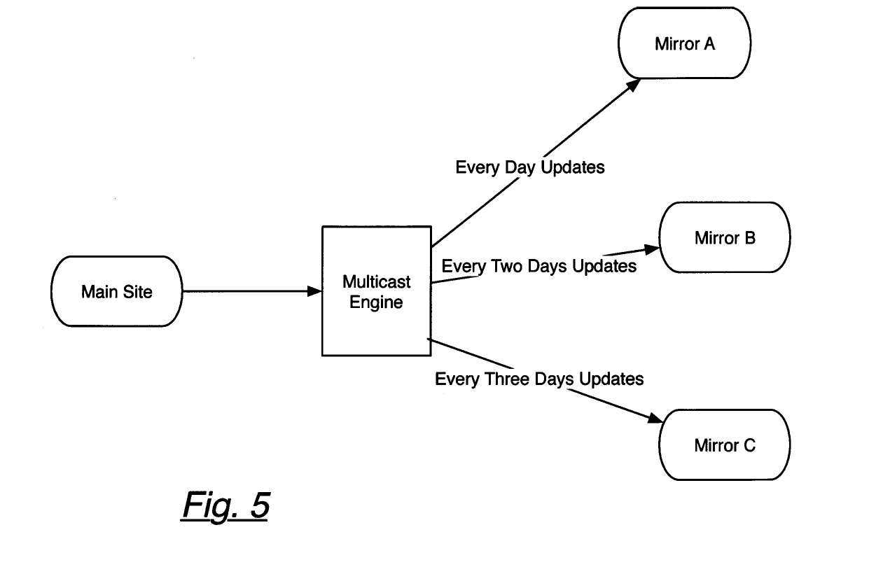

The weighted multicast table of the invention can also be applied to the updating of mirror web servers. FIG. 5 shows a main web server (“Main Site”) and three “mirror” servers (“Mirror A”, “Mirror B”, “Mirror C”) located in different parts of the world, all coupled to a multicast engine. The mirror sites distribute the load on the web site geographically. When the main web server is updated, the mirrors must be updated as well. Depending on the importance of the update to the mirror servers, the weighted multicast table can be used to differentiate the frequency of updates to different mirrors. Table 6 illustrates an example.

TABLE 6

| Mirror | Update Frequency |
|---|---|
| A | 1 |
| B | 2 |
| C | 3 |

In this example, the table entry “1” means “update every day”, “2” means “update every other day”, and “3” means “update every third day”.

An alternative implementation of assigning weights to streams is to associate additional columns in the table with each stream, each column representing a different weight. Thus, the table entries could remain binary and this will be more compatible with existing systems. Table 7 shows the same example as FIG. 1 and Table 2 but with only binary entries “0” and “1”

TABLE 7

| | Ch. 71 | Ch. 71-I | Ch. 72 | Ch. 72-I | Ch. 73 | Ch. 73-I |
|---|---|---|---|---|---|---|
| TV | 0 | 1 | 1 | 1 | 0 | 1 |
| Subscriber | | | | | | |

In Table 7 additional channel entries are provided for the I frames only streams. Thus, reading from left to right, the subscriber does not get a full channel 71 stream, gets a channel 71I frames stream, gets a full channel 72 stream, does not get a channel 72 I frames only stream (because the full stream including I frames is being sent), does not get a full channel 73 stream and does get a channel 73 I frames only stream.

There have been described and illustrated herein several embodiments of a weighted multicast table and applications utilizing it. While particular embodiments of the invention have been described, it is not intended that the invention be limited thereto, as it is intended that the invention be as broad in scope as the art will allow and that the specification be read likewise. Thus, while the invention has been described with reference to sending the full stream of one channel and I frames of adjacent channels, it will be appreciated that the I frames of more than just the adjacent channels could be sent. Moreover, rather then sending the I frames of adjacent channels, I frames for the user's favorite channels could be sent. Favorite channels could be determined by intelligence that keeps track of recently selected channels. It will therefore be appreciated by those skilled in the art that yet other modifications could be made to the provided invention without deviating from its spirit and scope as claimed.

What is claimed is:

1. In a telecommunications network having a source of a data stream and a recipient of said data stream, the improvement comprising:
a multicast engine coupled to the source of the data stream and to the recipient of the data stream; and
a multicast table associated with said multicast engine, wherein said multicast table indicates whether or not the data stream is forwarded to the recipient and if it is forwarded indicates at least two different manners of forwarding the data stream.

2. The improvement according to claim 1, wherein:
the at least two different manners of forwarding the data stream includes forwarding with different priority.

3. The improvement according to claim 1, wherein:
the data stream is an MPEG video stream and the at least two different manners of forwarding the video stream includes forwarding all frames and forwarding I frames only.

4. The improvement according to claim 3, wherein:
the at least two different manners of forwarding includes forwarding I frames only but marking I frames with a discard bit.

5. The improvement according to claim 1, wherein:
the data stream is a hybrid MPEG stream containing components of at least two different resolutions of the same content and the at least two different manners of forwarding the video stream includes forwarding the higher resolution content and forwarding the lower resolution content.

6. The improvement according to claim 6, wherein:
the hybrid MPEG stream includes both TV and HDTV components.

7. The improvement according to claim 6, wherein:
the hybrid MPEG stream includes a Vcast component.

8. The improvement according to claim 1, wherein:
the data stream is a teleconferencing stream containing audio and video components and the at least two different manners of forwarding the stream includes forwarding both the audio and video components and forwarding the audio component only.

9. The improvement according to claim 8, wherein:
the teleconferencing stream includes a desktop component and the at least two different manners of forwarding the stream includes forwarding the audio, video and desktop components and forwarding the audio and desktop components only.

10. The improvement according to claim 1, wherein:
the data stream is a data update and the at least two different manners of forwarding the stream includes forwarding updates daily and forwarding updates every other day.

11. The improvement according to claim 10, wherein:
the at least two different manners of forwarding the stream includes forwarding updates every third day.

12. A method of multicasting a data stream, comprising:
transmitting the data stream to a multicast engine;
associating a multicast table with the multicast engine;
coupling the multicast engine to a plurality of destinations;
transmitting the data stream from the multicast engine to one or more of the plurality of destinations according to one or more entries made in the multicast table, wherein
said one or more entries is one of at least three different values, the values indicating do not forward, forward in a first manner, and forward in a second manner.

13. The method according to claim 12, wherein:
the entire data stream is transmitted to a destination when the corresponding entry indicates forward in a first manner, and
less than the entire data stream is transmitted to a destination when the corresponding entry indicates forward in a second manner.

14. The method according to claim 13, wherein:
the entire data stream is an MPEG stream and less than the entire data stream is I frames only.

15. The method according to claim 13, wherein:
the entire data stream is a hybrid MPEG stream including components of different resolution, and
less than the entire data stream has lower resolution that the entire data stream.

16. The method according to claim 13, wherein:
the entire data stream is a teleconferencing data stream containing audio and video components, and
less than the entire data stream contains only the audio portion.

17. The method according to claim 12, wherein:
the data stream is a data update,
the data update is always transmitted when the corresponding entry indicates forward in a first manner, and
the data update is only transmitted every other day when the corresponding entry indicates forward in a first manner.

18. In a telecommunications network having a source of a video stream and a recipient of said video stream, the improvement comprising:
a multicast engine coupled to the source of the video stream and to the recipient of the video stream; and
a multicast table associated with said multicast engine, wherein said multicast table indicates whether or not the video stream is forwarded to the recipient and if it is forwarded indicates whether all of the video stream is forwarded or only some of the video stream is forwarded.

19. The improvement according to claim 18, wherein:
some of the video stream is MPEG I frames.

20. A method of multicasting a video stream, comprising:
transmitting the video stream to a multicast engine;
associating a multicast table with the multicast engine;
coupling the multicast engine to a plurality of destinations;
transmitting the video stream from the multicast engine to one or more of the plurality of destinations according to one or more entries made in the multicast table, wherein
said one or more entries is one of at least three different values, the values indicating do not forward, forward all of the video stream, and forward only part of the video stream.

21. The method according to claim 20, wherein:
only part of the video stream is MPEG I frames.
